(19) United States
(12) Patent Application Publication
(10) Pub. No.: US 2006/0109390 A1
(43) Pub. Date: May 25, 2006

(54) Liquid crystal projection system

(75) Inventor: Nai-Yueh Liang, Taipei City (TW)

Correspondence Address: BIRCH STEWART KOLASCH & BIRCH, PO BOX 747, FALLS CHURCH, VA, 22040-0747, US

(73) Assignee: Prodisc Technology Inc.

(21) Appl. No.: 11/110,777

(22) Filed: Apr. 21, 2005

(30) Foreign Application Priority Data
Nov. 24, 2004 (TW) 093136215
Dec. 28, 2004 (CN) 200410103455.2

(51) Int. Cl. G02F 1/1335

(52) U.S. Cl. 349/5

(57) ABSTRACT

A liquid crystal projection system includes a prism unit, a first imager unit, a second imager unit, a third imager unit, at least one light source, a first dichroic mirror and a second dichroic mirror. The first, second and third imager units are disposed at first, second and third sides of the prism unit, respectively. The first, second and third imager units respectively have first, second and third gradient filter devices. The light source emits a light beam forming a light route. The first dichroic mirror is disposed on the light route and adjacent to the light source. The second dichroic mirror is disposed on the light route. At least part of the light beam is transmitted to the first dichroic mirror and then to the second dichroic mirror. A transmission rate of a central area of each gradient filter device is smaller than that of an edge area.

### BACKGROUND OF THE INVENTION

1. Field of Invention

The invention relates to a projection system, and more particularly to a liquid crystal projection system.

2. Related Art

Recently, the liquid crystal display devices, such as the direct view monitors for the LCD monitors, the notebook computers and the digital liquid crystal televisions, and the in-direct view display panels, such as the LCoS Panel (Liquid Crystal on Silicon Panel), the HTPS-LCD (High Temperature Polysilicon Liquid Crystal Display) and the likes, for the monitors of the liquid crystal projectors, rear-projection televisions, and the likes, have been gradually and widely used in the daily life. Because the direct view monitor still has many limitations in the large-scale display, the liquid crystal projector and the rear-projection television, each of which has the large-scale display and uses the in-direct view display panel having high resolution in conjunction with an optical engine, have gradually become the mainstream.

The conventional liquid crystal projecting devices may be classified into a transmittive device and a reflective device. The transmittive liquid crystal display and the reflective liquid crystal projecting device have similar basic principles, wherein the transmittive liquid crystal display performs the modulation according to the light source passing through the LCD panel, while the reflective liquid crystal projecting device modulates the optical signal emitted from the light source according to the LCoS panel and then the modulated signal is reflected to the monitor. The LCoS panel is formed by coating a liquid crystal layer on a CMOS chip serving as a circuit substrate and a reflective layer, and then packaging the chip using a glass plate. So, the light beam emitted from the light source is reflected from the LCoS panel to the monitor.

Referring first to FIG. 1, a three-piece type transmittive liquid crystal projecting device 10 mainly includes a light source 11, dichroic mirrors 121, 122, reflecting mirrors 131, 132, 133, liquid crystal panels 141, 142, 143, a prism 15 and a projection lens 16. The light beam outputted from the light source 11 is split by the dichroic mirrors 121, 122 into red, green and blue light beams (hereinafter referred to as RGB light beams) in different light routes. Thereafter, the RGB light beams pass through the corresponding liquid crystal panels 141, 142 and 143 and then enter the prism 15, respectively. The prism 15 combines the light beams and transmits the image to the projection lens 16.

Referring next to FIG. 2, a reflective liquid crystal projecting device 20 includes a light source 21, dichroic mirrors 221, 222, reflecting mirrors 231, 232, 233, polarization beam splitters 241, 242, 243, transmittive liquid crystal panels (Liquid Crystal on Silicon Panels, LCoS Panels) 251, 252, 253, a prism 26, and a projection lens 27. The light beam outputted from the light source 21 passes the dichroic mirrors 221 and 222 and is then divided into RGB light beams in different light routes. The RGB light beams pass through the reflecting mirrors 231, 232, 233, which change the light routes of the RGB light beams, then enter the polarization beam splitter 241, 242 and 243, and are then reflected to the liquid crystal panels 251, 252 and 253, respectively. After the reflection, the ROB light beams enter the prism 26, which combines the light beams, and the image is transmitted to the projection lens 27.

In either the transmittive liquid crystal projecting device 10 or the reflective liquid crystal projecting device 20, however, because the paths of different parts of the reflected/retracted light beams of different colors are non-equivalent, the areas of the light beams reaching one surface of the transmittive/reflective liquid crystal panel are increased. Thus, the phenomena of reduced edge brightness and non-uniform luminance formed on the liquid crystal panel surface may occur.

In addition, to generate image with uniform luminance, the transmittive/reflective liquid crystal panel must process a pre-compensation of the light beam for increasing the luminance at the edge area. This will reduce the gray level that the DMD 17 can provide, so as to affect the final image quality.

It is therefore an important subjective of the invention to provide a liquid crystal projection system for solve the above-mentioned problems of non-uniform luminance and reduced gray level caused by the pre-compensation process.

### SUMMARY OF THE INVENTION

In view of the foregoing, the invention is to provide a liquid crystal projection system capable of making the image have uniform luminance.

To achieve the above, a liquid crystal projection system of the invention includes a prism unit, a first imager unit, a second imager unit, a third imager unit, at least one light source, a first dichroic mirror and a second dichroic mirror. The first imager unit, the second imager unit and the third imager unit are disposed at a first side, a second side and a third side of the prism unit, respectively. The first imager unit has a first gradient filter device, the second imager unit has a second Gradient filter device, and the third imager unit has a third gradient filter device. The light source outputs a light beam that forms a light route. The first dichroic mirror is disposed on the light route and adjacent to the light source. The second dichroic mirror is disposed on the light route. At least one part of the light beam is firstly transmitted to the first dichroic mirror and then to the second dichroic mirror. A transmission rate of a central area of each of the gradient filter devices is smaller than that of an edge area of the gradient filter device.

As mentioned above, the liquid crystal projection system of the invention utilizes the gradient filter device having the central area with a smaller transmission rate and the edge area with a larger transmission rate. Thus, after the light beam outputted from the light source passes through the gradient filter devices of the imager units, the luminance of the central area is smaller while the luminance of the edge area is higher so that the illumination light beam with the non-uniform luminance may be produced. Consequently, the phenomenon of the non-uniform image luminance caused by the unequal projection distances of the light beams projected on the imager units may be improved, and the image with uniform luminance may be obtained. Furthermore, it is unnecessary to waste the energy to pre-compensate the luminance. So, the gray level of the liquid crystal projection system may be increased, and the final image quality may be enhanced.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing a conventional transmittive liquid crystal projecting device;

FIG. 2 is a schematic illustration showing a conventional reflective liquid crystal projecting device;

FIG. 3 is a schematic illustration showing a liquid crystal projection system according to a first embodiment of the invention;

FIG. 4 is a schematic illustration showing a gradient filter device of the liquid crystal projection system according to the embodiment of the invention;

FIG. 5 is a schematic illustration showing a transmission rate variation of the gradient filter device of the liquid crystal projection system according to the embodiment of the invention; and

FIG. 6 is a schematic illustration showing a liquid crystal projection system according to a second embodiment of the invention.

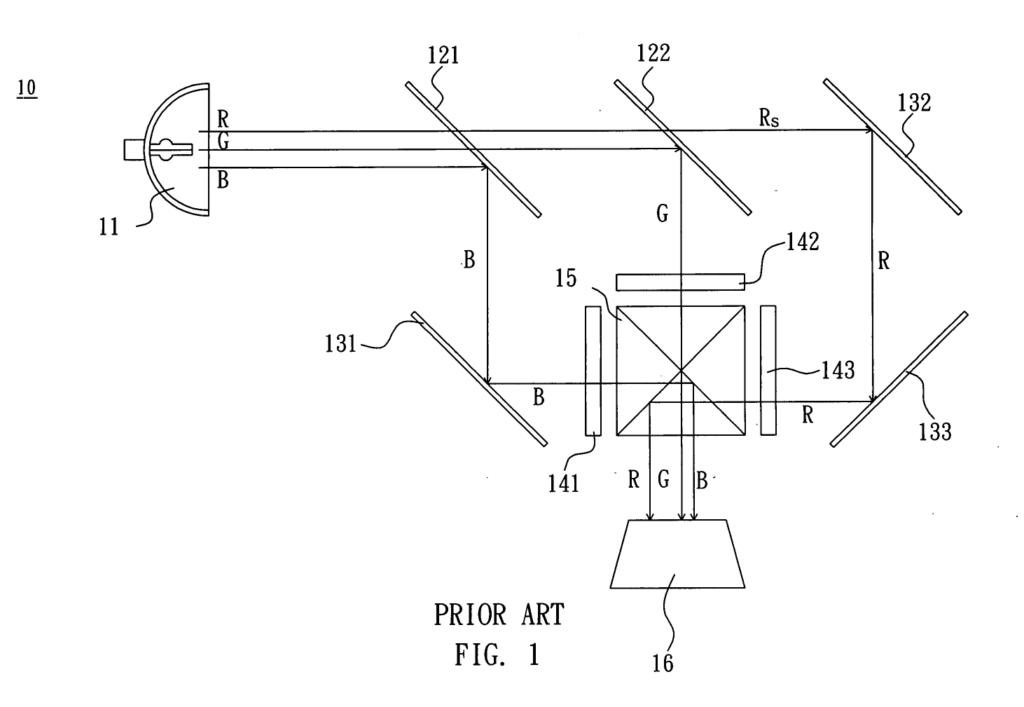

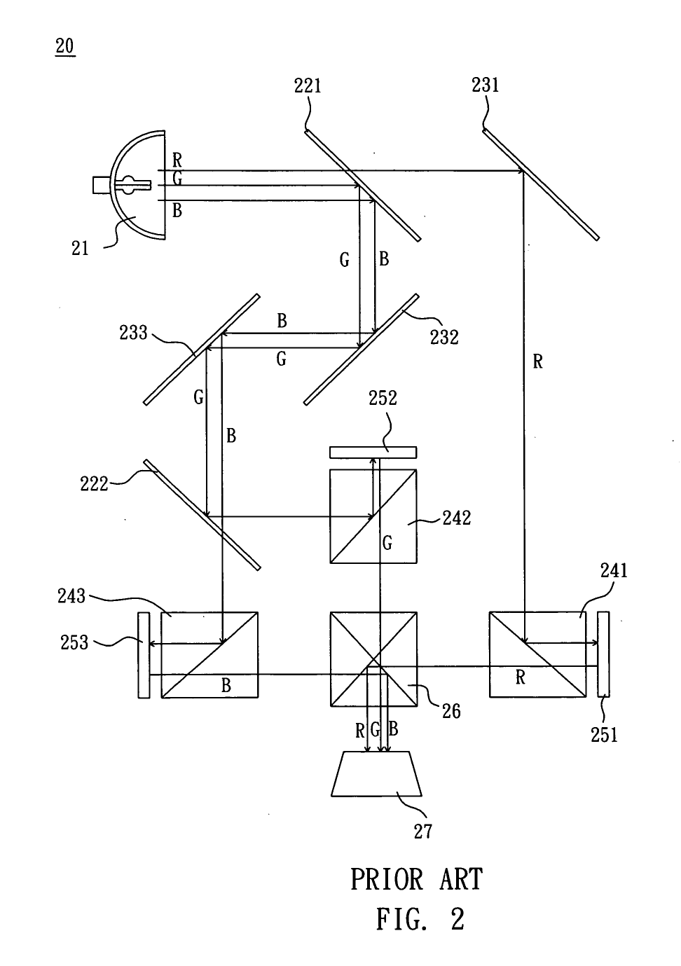

### DETAILED DESCRIPTION OF THE INVENTION

The present invention will be apparent from the following detailed description, which proceeds with reference to the accompanying drawings, wherein the same references relate to the same elements.

### First Embodiment

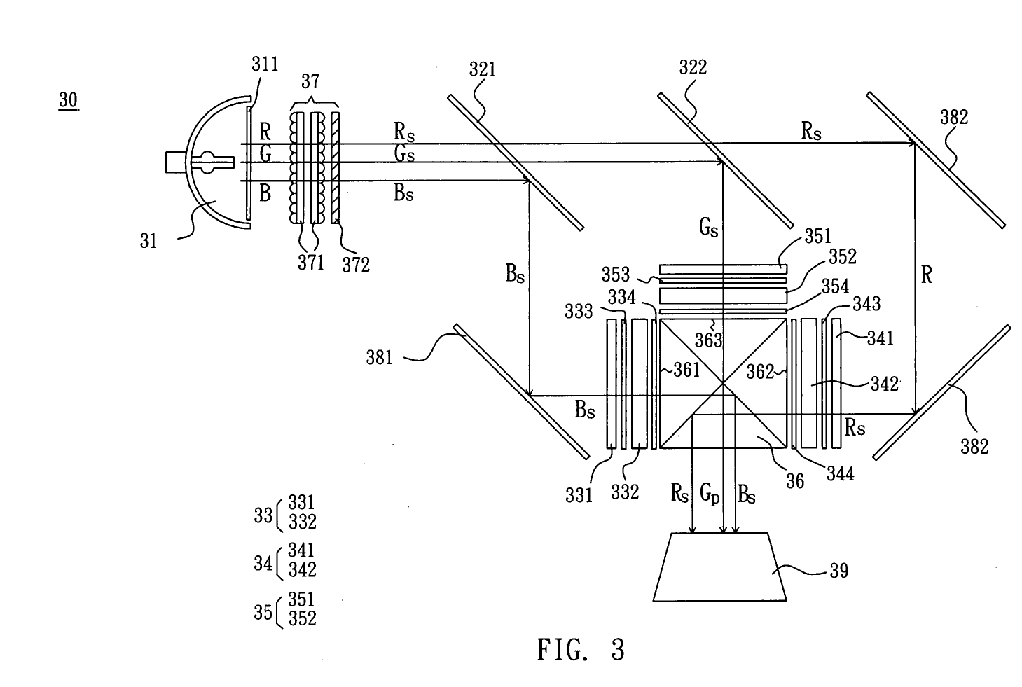

Referring to FIG. 3, a liquid crystal projection system 30 according to the first embodiment of the invention includes at least one light source 31, a first dichroic mirror 321, a second dichroic mirror 322, a first imager unit 33, a second imager unit 34, a third imager unit 35, and a prism unit 36. In this embodiment, the liquid crystal projection system 30 is applied in a transmittive liquid crystal projector.

The light source 31 emits a light beam, which forms a light route. In this embodiment, the light source 31 may be a lamp, an organic light-emitting diode (OLED), an organic light-emitting diode array (OLED array), a laser and a laser array. In addition, an ultra-violet/infrared cut-off filter 311 adjacent to the light source 31 filters the ultra-violet ray and infrared ray of the light beam.

In this embodiment, the liquid crystal projection system 30 further includes a first polarization beam splitter unit 37 disposed at a side of the light source 31. The light beam outputted from the light source 31 passes through the first polarization beam splitter unit 37 and is then transmitted to the first dichroic mirror 321. In this embodiment, the first polarization beam splitter unit 37 has a lens array 371 and a PBS (Polarization Beam Splitter) 372. The light beam outputted from the light source 31 firstly passes through the lens array 371, which homogenizes the light beams, and then passes through the PBS 372, which changes the polarization state of the light beam, such that the light beam is transmitted to the first dichroic mirror 321 in the form of S-polarized light beams Rs, Gs and Bs.

The first dichroic mirror 321 and the second dichroic mirror 322 disposed on the light route split the light beam. The first dichroic mirror 321 is adjacent to the light source 31. At least one part of the light beam is firstly transmitted to the first dichroic mirror 321 and then to the second dichroic mirror 322. In this embodiment, the first dichroic mirror 321 allows the light beams Rs and Gs to pass and reflects the light beam Bs. The second dichroic mirror 322 allows the light beam Rs to pass and reflects the light beam Gs to the third imager unit 35.

In this embodiment, the liquid crystal projection system 30 further includes a first reflecting mirror 381 disposed on the light route. After being reflected by the first dichroic mirror 321, the light beam Bs is then reflected by the first reflecting mirror 381 and transmitted to the first imager unit 33.

In this embodiment, the liquid crystal projection system 30 further includes a second reflecting mirror 382 disposed on the light route. The light beam Rs passes through the first dichroic mirror 321 and the second dichroic mirror 322, and is then reflected by the second reflecting mirror 382 and transmitted to the second imager unit 34. The numbers of the first reflecting mirror(s) 381 and the second reflecting mirror(s) 382 may be determined according to the actual manufacturing processes.

The first imager unit 33 disposed at a first side 361 of the prism unit 36 has a first gradient filter device 331. The second imager unit 34 disposed at a second side 362 of the prism unit 36 has a second gradient filter device 341. The third imager unit 35 disposed at a third side 363 of the prism unit 36 has a third gradient filter device 351. The transmission rate of a central area of each of the first gradient filter device 331, the second gradient filter device 341 and the third gradient filter device 351 is smaller than that of an edge area of the filter devices. The prism unit 36 may be a prism such as an X-prism.

With reference to FIGS. 3 and 4, each of the gradient filter devices 331, 341 and 351 has a transparent substrate and a gradient filter layer. For example, the gradient filter device 331 may have a gradient filter layer L1 disposed at a transparent substrate S by way of sputtering, coating and adhering such that the gradient filter layer L1 is combined with the transparent substrate S.

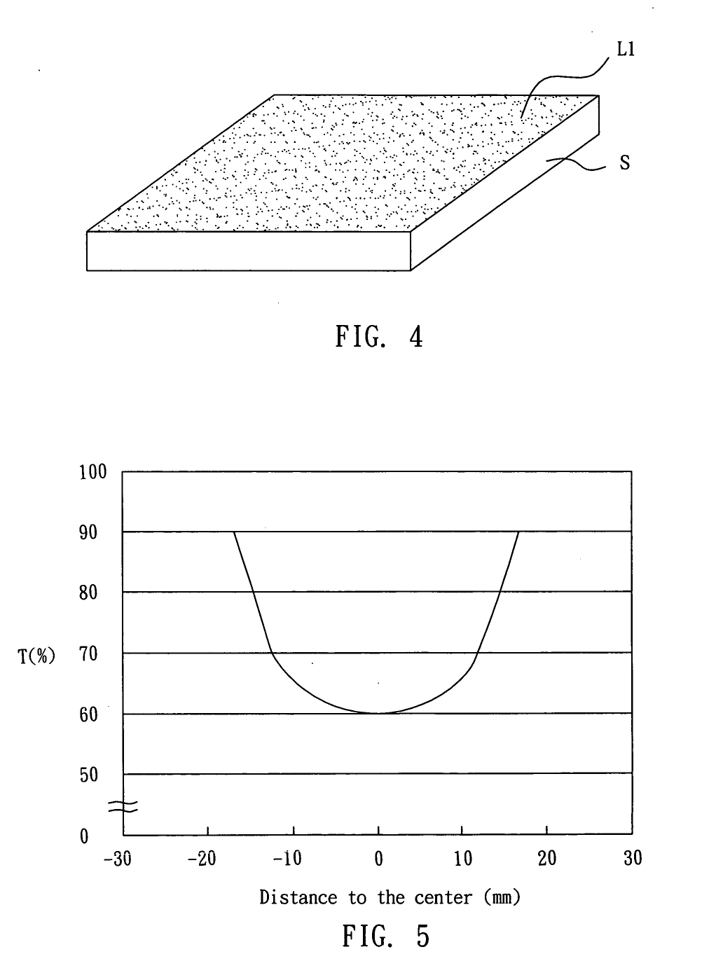

As shown in FIGS. 4 and 5, the transmission rate of the central area of the gradient filter layer L1 is smaller than that of the edge area. In FIG. 5, the x-axis represents the distance from any point on the gradient filter layer L1 to the center point, and the y-axis represents the transmission rate (T %). The transmission rate varies from the central to the edge area of the gradient filter layer L1. The central area has a lower transmission rate and the edge area has a higher transmission rate. The higher transmission rate represents the higher light flux. On the contrary, the lower transmission rate represents the lower light flux. Furthermore, the area size of the gradient filter layer may be adjusted according to the actual condition of the product. Of course, the gradient filter layers disposed on different transparent substrates may have different transmission rates, and the gradient filter layers with different transmission rates may be manufactured according to the manufacturing processes.

In this embodiment, the gradient filter layer may be a metallic reflective layer made of, for example, chromium or silver, or may be made of a dielectric material. The transmission rate of the central area of the gradient filter device 331, 341 or 351 may be made smaller than that of the edge area according to the different thicknesses or densities of the materials.

In this embodiment, the first imager unit 33 further has a first liquid crystal panel 332, the second imager unit 34 further includes a second liquid crystal panel 342, and the third imager unit 35 further includes a third liquid crystal panel 352. The light beams Bs, Rs and Gs are firstly transmitted to the gradient filter devices 331, 341 and 351, and then to the corresponding liquid crystal panels 332, 342 and 352, respectively. Each of the liquid crystal panels 332, 342 and 352 is a transmittive liquid crystal panel.

After the light beams are transmitted to the gradient filter devices 331, 341 and 351, and pass through the gradient filter layers with different transmission rates, the non-uniform luminance phenomenon caused by unequal light routes may be improved. Thus, the light beams with the uniform luminance may be transmitted to the liquid crystal panels 332, 342 and 352. So, the liquid crystal panels 332, 342 and 352 do not have to waste the energy to pre-compensate the brightness, and the gray level of the liquid crystal panels 332,342 and 352 can be increased.

The liquid crystal projection system 30 may further include a plurality of polarizers 333, 343 and 353 and a plurality of analyzers 334, 344 and 354. The polarizers 333, 343 and 353 are disposed between the gradient filter devices 331, 341 and 351 and the liquid crystal panels 332, 342 and 352, respectively, and the analyzers 334, 344 and 354 are disposed between the liquid crystal panels 332, 342 and 352 and the prism unit 36, respectively. The green analyzer 354 typically does not have the polarized light retarder effect. Thus, the light beam Gp still has the P polarization pattern after the light beam Gp, which has the polarization state being changed by the polarizer 353 into the P polarization pattern, passes through the analyzer 354, and directly passes through the prism unit 36. Because the prism unit 36 has the optical coating capable of selecting the wavelengths, the light beams Rs and Bs may be reflected out.

In this embodiment, the liquid crystal projection system 30 further includes a projection lens 39. The light beam is transmitted from the prism unit 36 to the projection lens 39. The light beams Rs, Gp and Bs are combined by the prism unit 36, and the images for the colors are superimposed. Then, the projection lens 39 projects the color frame with the uniform luminance.

### Second Embodiment

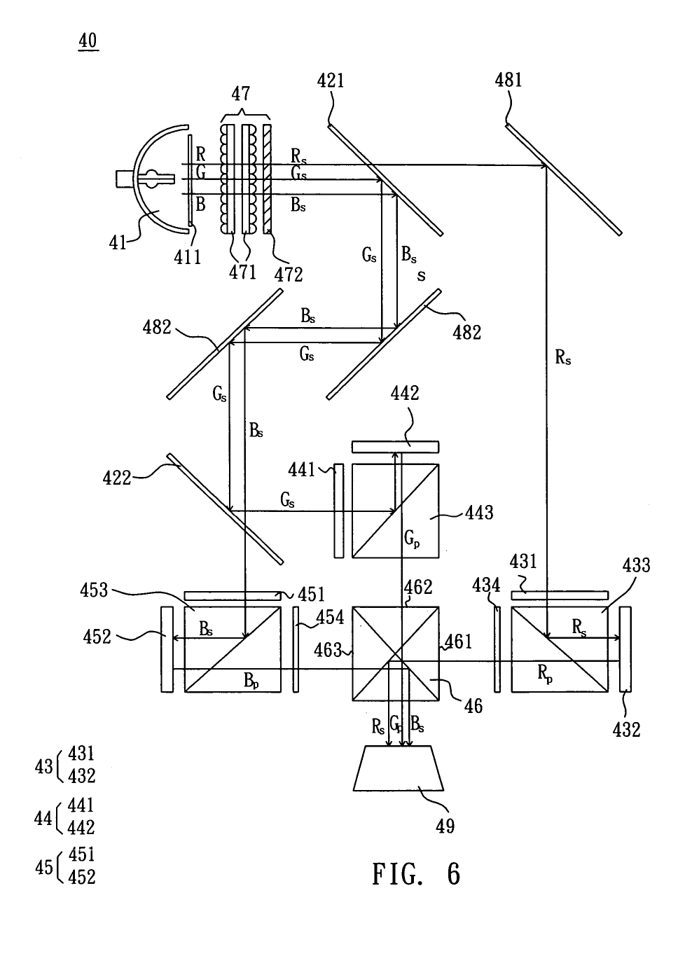

Referring to FIG. 6, a liquid crystal projection system 40 includes a light source 41, a first dichroic mirror.421, a second dichroic mirror 422, a first imager unit 43, a second imager unit 44, a third imager unit 45 and a prism unit 46. In this embodiment, the liquid crystal projection system 40 is applied in a reflective liquid crystal projector (such as a LCoS Projector).

The light source 41 emits a light beam that forms a light route. An ultra-violet/infrared cut-off filter 411 adjacent to the light source 41 filters the ultra-violet ray and infrared ray of the light beam. The features and functions of the light source 41, ultra-violet/infrared cut-off filter 411 and prism unit 46 of this embodiment are the same as those of the light source 31, ultra-violet/infrared cut-off filter 311 and prism unit 36 of the first embodiment, so the detailed descriptions are omitted for concise purpose.

In this embodiment, the liquid crystal projection system 40 further includes a first polarization beam splitter unit 47 disposed at a side of the light source 41 to change the polarization state of the light beam such that the light beam is transmitted to the first dichroic mirror 421 in the form of one of S-polarized light beams Rs, Gs and Bs. Herein, the features and functions of the first polarization beam splitter unit 47 of this embodiment are the same as those of the first polarization beam splitter unit 37 of the first embodiment, so the detailed descriptions are omitted for concise purpose.

The first dichroic mirror 421 and the second dichroic mirror 422 are disposed on the light route. The first dichroic mirror 421 is adjacent to the light source 41. At least one part of the light beam is firstly transmitted to the first dichroic mirror 421 and then to the second dichroic mirror 422.

In this embodiment, the liquid crystal projection system 40 further includes a first reflecting mirror 481 disposed on the light route. The light beam Rs passes through the first dichroic mirror 421, and is then reflected by the first reflecting mirror 481 and transmitted to the first imager unit 43.

In this embodiment, the liquid crystal projection system 40 further includes a second reflecting mirror 482 disposed on the light route. The light beam Gs is reflected by the first dichroic mirror 421, the second reflecting mirror 482 and the second dichroic mirror 422, and is then transmitted to the second imager unit 44. The light beam Bs is reflected by the first dichroic mirror 421 and the second reflecting mirror 482 and then passes through the second dichroic mirror 422. Then, the light beam Bs is transmitted to the third imager unit 45. The numbers of the first reflecting mirror(s) 481 and the second reflecting mirror(s) 482 may be determined according to the actual manufacturing processes.

The first imager unit 43 disposed at a first side 461 of the prism unit 46 has a first gradient filter device 431. The second imager unit 44 disposed at a second side 462 of the prism unit 46 has a second gradient filter device 441. The third imager unit 45 disposed at a third side 463 of the prism unit 46 has a third gradient filter device 451. The features and functions of the first gradient filter device 431, second gradient filter device 441, third gradient filter device 451, and prism unit 46 of this embodiment are the same as those of the first gradient filter device 331, second gradient filter device 341, third gradient filter device 351, and prism unit 36 of the first embodiment, so the detailed descriptions are omitted for concise purpose.

In this embodiment, the first imager unit 43 further has a first liquid crystal panel 432, the second imager unit 44 further includes a second liquid crystal panel 442, and the third imager unit 45 further includes a third liquid crystal panel 452. The light beams are firstly transmitted to the gradient filter devices 431, 441 and 451, and then to the corresponding liquid crystal panels 432, 442 and 452, respectively. Each of the liquid crystal panels 432, 442 and 452 is a reflective liquid crystal panel (such as a LCoS Panel). The reflective liquid crystal panel has a CMOS chip serving as the substrate and the reflective layer, on which a liquid crystal layer is coated. Then, a glass plate is used to package the CMOS chip such that the light beam emitted from the light source 41 is reflected by the reflective liquid crystal panel.

After the light beams are transmitted to the gradient filter devices 431, 441 and 451 and then pass through the gradient filter layers with different transmission rates, the non-uniform luminance phenomenon caused by unequal light routes may be improved. Thus, the light beams with the uniform luminance may be transmitted to the liquid crystal panels 432, 442 and 452. So, the liquid crystal panels 432, 442 and 452 do not have to waste the energy to pre-compensate the brightness, and the gray levels of the liquid crystal panels 432, 442 and 452 can be increased.

With reference to FIG. 6, the liquid crystal projection system 40 further includes a plurality of second polarization beam splitter units 433, 443 and 453 and a plurality of polarization retarders 434 and 454. The light beams firstly pass through the gradient filter devices 431, 441 and 451 and then the second polarization beam splitter units 433, 443 and 453 and then enter the liquid crystal panels 432, 442 and 452. Thereafter, the modulated light beams pass through the second polarization beam splitter units 433, 443 and 453 and the polarization retarders 434 and 454. Each of the second polarization beam splitter units 433, 443 and 453 may be a polarization splitter prism.

Because each of the second polarization beam splitter units 433, 443 and 453 has an optical coating, which can select the polarization, the light beams passing through the gradient filter devices 431, 441 and 451 may be reflected to the panels 432, 442 and 452. The S-polarized light beam Rs entering the first liquid crystal panel 432 is converted into the P-polarized light beam Rp, which again enters the second polarization beam splitter unit 433 from the first liquid crystal panel 432. The light beam Rp penetrates through the optical coating of the second polarization beam splitter unit 433, and is then converted by the polarization retarder 434 into the S-polarized light beam Rs, which is transmitted to the prism unit 46. Similarly, the S-polarized light beams Gs and Bs entering the second liquid crystal panel 442 and the third liquid crystal panel 452 are converted into the P-polarized light beams Gp and Bp, which enter the second polarization beam splitter units 443 and 453 from the second liquid crystal panel 442 and the third liquid crystal panel 452, respectively. The light beam Gp directly passes through the optical coating of the second polarization beam splitter unit 443 and directly enters the prism unit 46. The light beam Bp penetrates through the optical coating of the second polarization beam splitter unit 453, and is converted by the polarization retarder 454 into the S-polarized light beam Bs, which is transmitted to the prism unit 46.

In this embodiment, the liquid crystal projection system 40 further includes a projection lens 49. The light beams Rs, Bs and Gp outputted from the prism unit 46 are transmitted to the projection lens 49. The light beams Rs, Gp and Bs are combined by the prism unit 46, and the images for the colors are superimposed. Then, the projection lens 49 projects the color frame with the uniform luminance.

In summary, the liquid crystal projection system of the invention utilizes the gradient filter device having the central area with a smaller transmission rate and the edge area with a larger transmission rate. Thus, after the light beam outputted from the light source passes through the gradient filter devices of the imager units, the phenomenon of the non-uniform image luminance caused by the unequal projection distances of the light beams projected on the imager units may be improved, and the image with uniform luminance may be obtained. Therefore, it is unnecessary to waste the energy to pre-compensate the luminance. So, the gray level of the liquid crystal projection system may be increased, and the final image quality may be enhanced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A liquid crystal projection system, comprising:
a first imager unit disposed at a first side of the prism unit and having a first gradient filter device;
a second imager unit disposed at a second side of the prism unit and having a second gradient filter device;
a third imager unit disposed at a third side of the prism unit and having a third gradient filter device;
at least one light source for emitting a light beam to form a light route;
a first dichroic mirror disposed on the light route and adjacent to the light source; and
a second dichroic mirror disposed on the light route, wherein at least one part of the light beam is firstly transmitted to the first dichroic mirror and then to the second dichroic mirror, and a transmission rate of a central area of each of the first gradient filter device, the second gradient filter device and the third gradient filter device is smaller than a transmission rate of an edge area of the gradient filter device.

2. The liquid crystal projection system of claim 1, wherein the prism unit is a prism.

3. The liquid crystal projection system of claim 1, wherein each of the first gradient filter device, the second gradient filter device and the third gradient filter device has a transparent substrate and a gradient filter layer disposed on the transparent substrate.

4. The liquid crystal projection system of claim 3, wherein the gradient filter layer is made of one selected from a metal and a dielectric material.

5. The liquid crystal projection system of claim 1, wherein the first imager unit further comprises a first liquid crystal panel, the second imager unit further comprises a second liquid crystal panel, the third imager unit further comprises a third liquid crystal panel, and the light beam is firstly transmitted to the first gradient filter device, the second gradient filter device and the third gradient filter device, and then to the first imager unit, the second imager unit and the third imager unit.

6. The liquid crystal projection system of claim 5, wherein each of the first liquid crystal panel, the second liquid crystal panel and the third liquid crystal panel is a transmittive liquid crystal panel.

7. The liquid crystal projection system of claim 5, wherein each of the first liquid crystal panel, the second liquid crystal panel and the third liquid crystal panel is a reflective liquid crystal panel.

8. The liquid crystal projection system of claim 6, further comprising:
a first reflecting mirror disposed on the light route, wherein at least one part of the light beam is reflected with the first dichroic mirror, is reflected with the first reflecting mirror, and reaches the first imager unit.

9. The liquid crystal projection system of claim 6, further comprising:
a second reflecting mirror disposed on the light route, wherein at least one part of the light beam passes through the first dichroic mirror and the second dichroic mirror, is reflected with the second reflecting mirror, and then reaches the second imager unit.

10. The liquid crystal projection system of claim 6, wherein at least one part of the light beam is transmitted through the first dichroic mirror, is reflected with the second dichroic mirror, and then reaches the third imager unit.

11. The liquid crystal projection system of claim 7, further comprising:
a first reflecting mirror disposed on the light route, wherein at least one part of the light beam is reflected with the first dichroic mirror, is reflected with the first reflecting mirror, and reaches the first imager unit.

12. The liquid crystal projection system of claim 7, further comprising:
a second reflecting mirror disposed on the light route, wherein at least one part of the light beam is reflected with the first dichroic mirror, the second reflecting mirror and the second dichroic mirror, and then reaches the second imager unit.

13. The liquid crystal projection system of claim 12, wherein at least one part of the light beam is reflected with the first dichroic mirror and the second reflecting mirror, passes through the second dichroic mirror, and then reaches the third imager unit.

14. The liquid crystal projection system of claim 1, wherein the light source is at least one selected from a lamp, an organic light-emitting device, an organic light-emitting diode array, a laser, and a laser array.

15. The liquid crystal projection system of claim 1, further comprising a first polarization beam splitter unit, which is disposed at a side of the at least one light source, wherein the light beam outputted from the at least one light source passes through the first polarization beam splitter unit and is then transmitted to the first dichroic mirror.

16. The liquid crystal projection system of claim 15, wherein the first polarization beam splitter unit comprises a lens array and a polarization beam splitter, and the light beam firstly passes through the lens array and then reaches the polarization beam splitter.

17. The liquid crystal projection system of claim 15, wherein the first polarization beam splitter unit is a prism.

18. The liquid crystal projection system of claim 5, wherein each of the first imager unit, the second imager unit and the third imager unit further comprising a second polarization beam splitter unit, and at least one part of the light beam firstly passes through the corresponding one of the first gradient filter device, the second gradient filter device and the third gradient filter device, passes through the corresponding second polarization beam splitter unit, and reaches the first liquid crystal panel, the second liquid crystal panel and the third liquid crystal panel.

19. The liquid crystal projection system of claim 18, wherein the second polarization beam splitter unit is a polarization splitter prism.

20. The liquid crystal projection system of claim 1, further comprising:
a projection lens, wherein the light beam is emerged from the prism unit and then projected to the projection lens.
